(19) United States
(12) Patent Application Publication
(10) Pub. No.: US 2002/0155330 A1
(43) Pub. Date: Oct. 24, 2002

(54) Fuel cell system and hydrogen-generating system therefor

(76) Inventor: Hideaki Tanaka, Toyonaka-shi (JP)

Correspondence Address: JONES, VOLENTINE, STEINBERG & WHITT, L.L.P., Suite 150, 12200 Sunrise Valley Drive, Reston, VA, 20191, US

(21) Appl. No.: 10/076,476

(22) Filed: Feb. 19, 2002

(30) Foreign Application Priority Data
Feb. 20, 2001 (JP) 2001/94316

(51) Int. Cl. H01M 8/06

(52) U.S. Cl. 429/19; 429/9; 429/21

(57) ABSTRACT

A fuel cell system comprises at least one unit of fuel cells and auxiliary soluble metal anode batteries for producing hydrogen gas by dissolution of a soluble metal in an electrolyte. The fuel cell system may comprises at least one unit of fuel cells; an electrolysis system operated under a high pressure to generate hydrogen gas and oxygen gas and adapted to supply these gases to said fuel cells, and an auxiliary power source for supplying an electric power to said electrolysis system.

### BACKGROUND OF THE INVENTION

The present invention relates to a fuel cell system and a hydrogen-generating system therefor.

Conventionally, oil fuels have been used for most of automobiles but their contribution to global warming and environment pollution facilitates the conversion from oil to other energy sources. In the United States of America, use of fossil fuel is banned from 2003 because of global warming and sanitary harmful results caused by auto exhausts. To solve the above problems, there have been developed various types of internal combustion engines employing as a fuel methanol, natural gas or the like. However, all the fuels can not be regarded as a clean energy as long as the automobile engines employ the combustion system.

For these reasons, hydrogen gas is attracting much attention as a clean energy and as an alternative to oil from the industrial circles including the car industry lately. The produced hydrogen gas is liquefied and then charged in steel cylinders to use it as a fuel for internal combustion engines. However, the use of such automobiles is confined to a narrow zone since nationwide distribution network for supply of hydrogen gas is far from being complete. In addition, there is a high risk of gas explosion hazard as long as the automobiles use the combustion system.

On the other hand, the car industry is in a developmental stage of vehicles powered by a fuel cell, which comprises two electrodes, i.e., an anode and a cathode, separated by an electrolyte and converts chemical energy of hydrogen and oxygen to electrical energy. In the fuel cell, hydrogen gas supplied to the anode reacts with oxygen gas supplied to the cathode to form water and electrons produced by reaction can be taken out as electric power.

Most of the hydrogen gas for industrial uses is generally produced by reforming of hydrocarbons such as natural gas and oil. Also, catalytic cracking of alcohol such as methanol can produce the hydrogen. However, fuel reformers or catalytic crackers used in such process increase in size with increasing scale of production. In addition, the produced hydrogen is not pure hydrogen and thus the product requires purification to remove byproducts or impurities.

For this reason, hydrolysis of water is attracting much attention since it enables production of pure hydrogen and since water can be regarded as an inexhaustible source of hydrogen. The hydrolysis of water is carried out with an electric power generated by thermal power generation, nuclear power generation and the like.

However, the hydrolysis of water requires a large amount of external energy and thus there is an increasing demand of reductions in cost for hydrogen production.

### SUMMARY OF THE INVENTION

It is therefore an object of the present invention to provide a fuel cell system with a hydrogen gas-generating system for fuel cells, which enables to mass-produce pure hydrogen gas at a lower cost and to increase an energy efficiency of electrolysis.

According to the present invention, there is provided a fuel cell system comprising a fuel cells; an electrolysis system operated under a high pressure to generate hydrogen gas and oxygen gas and adapted to supply these gases to said fuel cells, and an auxiliary power source for supplying an electric power to said electrolysis system.

As a power source for the electrolysis system, there may be used metal anode batteries, wind power generators and/or photovoltaic power generators. The metal anode batteries include aluminum□batteries, manganese batteries, zinc batteries and similar batteries including metal anodes which is soluble in an electrolyte to generate an electric power and produce hydrogen gas as a byproduct. The electric power generated is supplied to the high pressure electrolysis system to use it as an external power, while the hydrogen gas produced as a byproduct is supplied to the fuel cell system to use it as a fuel. Such metal anode batteries generally comprises soluble metal anodes and insoluble cathodes separated one another by separators and arranged in a casing or tank containing an electrolyte. When the metal anode dissolves in the electrolyte, it provides electrons and produces hydrogen gas.

An amount of the hydrogen gas produced in the metal anode batteries is insufficient to operate the fuel cell system, so that the hydrogen gas is additionally produced by the high-pressure electrolysis system. The electrolysis under the high pressure makes it possible to improve an electric efficiency by 20% at the least.

When generating the electric power required for the operation of the electrolysis system by wind power generators, hot waste water or hot spring water may be used to rotate electric generators. On the oceans of planet, the photovoltaic power generators are used to generate the electric power required for the operation of the electrolysis system. In that case, the photovoltaic power generators are floated on the sea, while the high pressure electrolysis system is immersed in the deep sea of about 200 to 1000 m to generate hydrogen gas. Since the high electrolysis system produces oxygen gas as a byproduct, the resultant oxygen gas can be used to perform oxidative purification of marine sediments or sludge which cause break out an outbreak of red tide. Thus, if the fuel cell system of the present invention is located near the fish farm, oxidative purification of marine sediments or sludge makes it possible to prevent marine contamination resulting from marine culture and contributes to cultivate fishes and shellfish free from diseases.

It is difficult with the conventional wind power generators to produce a constant electric power as the force of wind varies with time or seasons. In order to generate electric power even under the dead calm, the wind power generator used in the fuel cell system of the present invention comprises a forced rotation vane composed of plural hollow blades, each of which contains a volatile solvent charged in an internal space thereof and is adapted to be heated by hot waste water or hot spring water when a tip portion of the blade comes down. In this case, the volatile solvent is vaporized by partial heating the blade, so that the vane shifts its gravity point and is rotated forcedly. Thus, the generator arranged in a central position of the vane is rotated to produce an electric power under the dead calm, thus making it possible to improve the power generation by 20%.

It has now been found that the electrolysis of water at a high pressure improves an ion transportation value. For example, if the hydrolysis of water is carried out in air at a pressure of 10 atm (1010 kPa), the ion transportation value is doubled as compared with that at a pressure of 1 atm (101 kPa). The greater the pressure, the greater is the ion transportation value, which in turn causes reduction of the electric power required for electrolysis. Thus, if the hydrolysis is carried out at greater ocean depths, the required electric power is decreased with increase of the ocean depth. For example, the hydrolysis at a depth of 10 m requires the electric power corresponding to that of the electrolysis at 1 atm, but the hydrolysis at a depth of 200 m requires only 1/10 of the electric power required for hydrolysis at a pressure of 101 kPa. Accordingly, the if the hydrolysis is carried out at a depth greater than 200 m, for example, at a depth of 1000 m, the required electric power would be further decreased. In fact, this causes increase of concentration of heavy hydrogen gas and decrease of the salt concentration, and thus too much depth may cause the efficiency of electrolysis in some cases. However, the high-pressure hydrolysis contributes to reduction of the production cost of hydrogen gas.

For example, the electrolysis of seawater with 3% concentration of salt requires 35 kW per 1000 kg at normal pressures, but the power requirements can be reduced to 17.5 kW at the depth of 10 atm (1010 kPa), and to 2-5 kW at the depth of 100 atm (10100 kPa). The high-pressure hydrolysis can be done above ground, but it requires expensive flame-proof apparatus. In contrast therewith, the deep-sea hydrolysis can be carried out with a simple system. For example, the electrolysis system may be composed of a single pipe with a diameter of 10 cm, which ha been partitioned into two parts along the entire length thereof, an electrolysis vessel arranged at the lower end of the pipe, and a pair of electrodes each being arranged in a space communicated with each part of the pile to separately collect hydrogen gas and oxygen gas. It is also possible to provide the electrolysis system at the end of a suction pipe arranged in deep waters to pump the deep-sea water at a depth of about 200 to 1000 m. In this case, it is preferred to use a solar battery system as a power source for the high-pressure electrolysis system. The solar battery system may be comprised of at least one floating support, plural solar panels arranged on surface of the support and electrically connected one another to supply an electric power of a desired voltage and a desired current to the electrolysis system through connecting wires. The solar panels may be mounted on plastic foamed supports having 1 m (width)×2 m (length)×10 cm (thick) and covered with a thin transparent plastic film.

When the fuel cell system of the present invention is applied to automobiles, the fuel cell system may be composed of a fuel cell system and auxiliary soluble metal anode batteries for producing hydrogen gas by dissolution of the metal in the electrolyte. The combination of fuel cells and auxiliary metal anode batteries makes it possible to supply hydrogen gas as a fuel for the fuel cell system safely at a low price. For example, consumption of 500 g of the anode metal makes it possible to drive a car at a speed of 80 kg/hr for 10 hours since the metal provides an electric current of 600 to 700 Ah per 1 g. The residue produced by reactions of the metal anode may be recycled as its metal oxide by neutralization of the electrolyte. The dissolved zinc compound may be collected as a metal by high-pressure electrolysis, and the collected metal zinc may be reused after casting. The metal oxide may be used a refractory raw material.

The metals for anodes include metallic sodium, metal calcium, metallic potassium, metallic lithium, zinc, aluminum, manganese and the like. If the metal anode is of metallic sodium, metal calcium, metallic potassium or metallic lithium, it is preferred to use alcohol-glycol solution, or a solution containing polyacrylate as electrolyte. Iron may be used as the soluble anode in combination with a glycol chelate solution of titanic acid, zirconic acid, hafnic acid, stanic acid or silicic acid. The cathode for electrolysis may be made of a material selected from the group consisting of carbon, silver chloride, silver, palladium, platinum, iron-silicon alloys, and silicon-manganese alloys.

The separating membranes or separators for the fuel cells may be made of plastic films of polyamide, polyolefine resins, polyester resins, polyurethane resin, or acrylic resin and containing lithium carbonate, or potassium hydroxide, or sodium-potassium peroxide dispersed therein. However, the separating membranes may be made of any known plastic film.

The present invention will be explained in detail below by way of embodiments shown in the drawings.

### BRIEF DESCRIPTION OF THE DRAWINGS

FIG. 1 is an oblique perspective view of an aluminum cathode battery in accordance with the present invention.

FIG. 2 is an oblique perspective view of the aluminum cathode battery closed with a top cover.

FIG. 3 is a process chart of a generator combining the aluminum battery with a fuel cell in accordance with the present invention.

FIG. 4 is a side view of a hydrogen producing tank in accordance with the present invention.

FIG. 5 is a side view of an automobile loaded with the fuel cell and the aluminum battery in accordance with the present invention.

FIG. 6 is a front view of an aluminum cathode used in the aluminum battery in accordance with the present invention.

FIG. 7 is an enlarged side view of the fuel cell.

FIG. 8 is a front view of a wind power generator in accordance with the present invention.

FIG. 9 is a front view of a hot water assisted wind power generator in accordance with the present invention.

FIG. 10 is a side view of a generator combining a wind power generator with a hot water assisted generator in accordance with the present invention.

FIG. 11 is a side view of a hot water assisted generator in accordance with the present invention.

FIG. 12 is a side view of a combination of an electrolytic device located in deep waters, a solar battery system on the sea and rafts for cultivating fish and shellfish in accordance with the present invention.

FIG. 13 is an expanded side view of the electrolytic device.

### DETAILED DESCRIPTION OF THE INVENTION

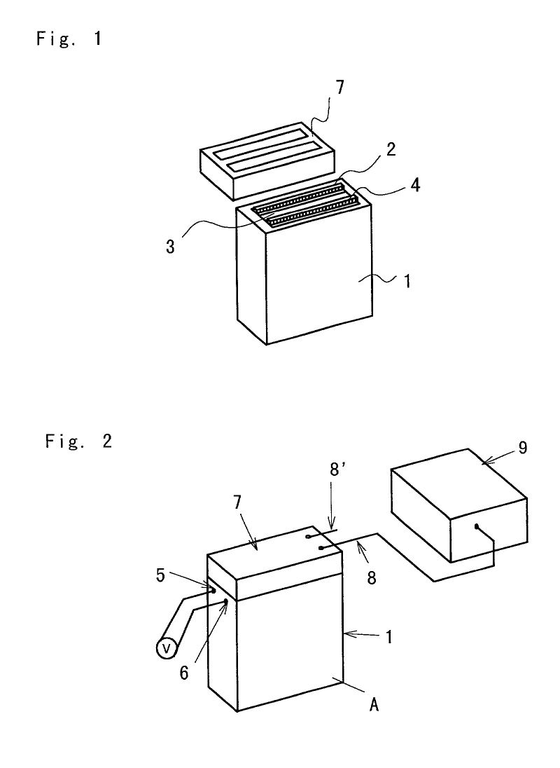

Referring now to FIG. 1, there is shown an aluminum cathode battery comprising a plastic electrolytic bath (1), a carbon pole (2) fitted into said bath (1), diaphragms (3) laminated and contacted to said pole (2), and an aluminum metal pole (4). The electric poles are connected to a conducting wire and joined to terminals (5) and (6). The battery is provided with a hollow top cover fitted on the electrolytic bath (1) for closing, and fed with an electrolytic solution for electrolysis.

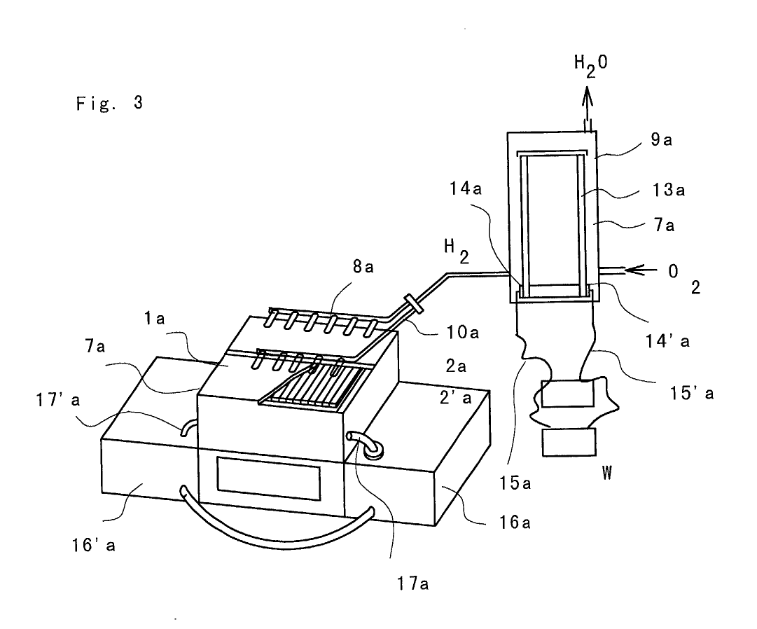

FIG. 2 is an oblique perspective view of the aluminum cathode battery closed with the top cover, wherein the top cover (7) is fitted on the electrolytic bath (1) for closing. In FIG. 2, (5) represents an anode terminal, (6) represents a cathode terminal, and (8) represents an outlet pipe for hydrogen gas. The electrolysis battery (A) is fed with an electrolytic solution and the aluminum cathode is immersed in the solution. Shortly after then, the immersed aluminum cathode starts to dissolve producing hydrogen gas. The resultant hydrogen gas rises to the top cover (7) passing though the solution with bubbling and accumulates in partitioned spaces of the top cover (7), and fed through the outlet pipe (8) formed on the compartments of the top cover (7) to fuel cells. To constitute a fuel cell, a core board is provided on one face thereof with a cathode diaphragm and on the other face with an anode diaphragm. In this constitution, hydrogen is blown into the cathode diaphragm and air containing oxygen is blown into the anode diaphragm, so that electric current flows between electrodes, previously joined to the both diaphragms.

In the constitution of the fuel cell (9), hydrogen reacted with the air containing oxygen to generate two electrons (2e⁻) by the following equation:

2H₂+O₂→2H₂O

FIG. 3 illustrates a process chart of a generator combining the aluminum battery with a fuel cell. The aluminum battery (A) comprises 12 batteries shown in FIGS. 1 and 2, a large body (1a), and a hollow top cover (7a) fitted on an upper portion of the body (1a) for closing, which batteries are fitted into the body (1a). To the top cover (7a) lead-out pipes for hydrogen gas (8a) are joined, and hydrogen is fed to fuel cells through the pipes and a rubber tube (10a). Between them, an intermediate accumulation can (11a) is connected. Through this can, hydrogen is blown into a diaphragm face (12a) in a cathode room of a fuel cell (9a). On the other hand, air containing oxygen gas is blown into an anode room of the fuel cell (9a). At that time, electricity is produced and runs through conducting wires (15a) and (15′a) connected to a cathode (14a) and an anode (14′a).

12 or 13 fuel cells are used as one set so as to generate 35 volts together. Then, hydrogen is blown into a plurality of the fuel cells for electric generation.

With respect to the electrode, as a cathode, titanium pieces or sintered silicone pieces may be used, and as an anode, titanium pieces, sintered silicon-manganese pieces, platinum-plated pieces and palladium pieces may be used.

In the aluminum battery (A) an electrolytic solution is contained and stored in tanks (16a) and (16′a) for a time. The electrolytic solution is introduced into the electrolytic bath (1a) through a flexible pipe (17a) with a pump or with an elevator, so that the metal cathode (2a) and anode (2′a) are contacted to the electrolytic solution from their lower portions.

For that purpose, the bottom portion of the electrolysis bath (1) shown in FIGS. 1 and 2 may be bottomless, reticulated or porous.

When stopping the operation, the electrolytic tanks (16a) and (16′a) are lowered below the aluminum battery, or the electrolytic baths are elevated or lowered such that an electrolytic solution is pooled without contact with the metal electrodes (2a) and (2′a).

As described above, in the case where an electrolytic solution is pooled in the tanks (16a) and (16′a), the metal electrodes are insulated from the electrolytic solution, so that there is no evolution of gases, which corrodes the metal electrodes. In order to insulate hydrogen gas from the air in small cases shown in FIGS. 1 and 2 provided therein with the unit cells, it is required that though separated by a partition board a certain amount of an electrolytic solution remains in the bottom portion of the cases. In particular, if gases generated by electrolysis in the anode are not individually separated and mixed with hydrogen gas, explosion may occur. Thus, it is necessary to provide the pipe (17′a) with a cock valve for regulation.

Thus, it is required that the electrodes (2a) and (2′a) be relatively short. In general, when the batteries are used, electrodes are consumed from their lower portions and therefor become short over time. Some (A″) of the aluminum batteries (A) are installed for backup and hydrogen gas tubes are connected to the gas storage cans (1a) in addition to the aluminum batteries (A′), to enable the generator to operate for a long time.

In the case of tracks, since a long-distance track carries 3 to 6 light oil tanks (each 100 liter), a track driven by electricity also need to carry 3 to 6 aluminum batteries on a loading space thereof. With regard to cathode plates, when passenger cars use 5 m/m thickness plates and tracks use 10 m/m thickness boards, no trouble will occur in long hours of travelling.

These metal cathodes are dissolved and consumed in operation. For replacement, the tanks shown in FIGS. 1 and 2 are lifted out from the large electrolysis bath (1a) before replacement with new tanks.

In a unit like this, it is possible to operate fuel cells (B) and aluminum batteries simultaneously. Further, only either fuel cells or aluminum batteries, for example, only aluminum batteries can drive an automobile.

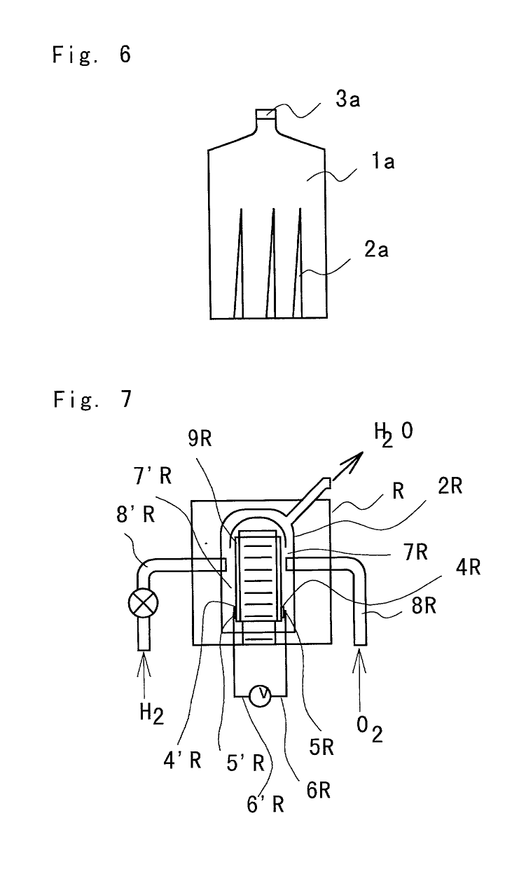

To increase the amount of hydrogen gas produced by the aluminum battery, it is effective to increase the alkaline level or acidic level of an electrolytic solution. FIG. 6 is an elevational view illustrating an aluminum cathode of the aluminum battery. When the aluminum cathode is provided with a lot of holes on a surface thereof to increase a contacting area with an electrolytic solution, a desirable result will be obtained. In particular, cathodes produced by sintering are useful because they are porous.

Automobiles use cathodes measuring 12 cm×12 cm×0.5 cm. In general, 12 to 20 diaphragms are laminated, and carbon anodes and iodinated polyacetylene resin are used therefor. On the other hand, tracks use cathodes measuring 26 cm×20 cm×1 cm. It may be convenient that long-distance tracks load 2 to 4 aluminum batteries.

For replacement of electrolytic solutions, storage tanks for electrolytic solution (16) and (16′a) are replaced. For reuse, used electrolytic solution is neutralized, and resultant precipitates and soluble matters are separated by filtration by filter press, to which an alkaline conditioner is added. Alternatively, a used solution is separated and resultant solution may be reused as such. In this case, it is also necessary to adjust the solution with an alkaline conditioner. Then, it is reused as an electrolytic solution. When a used acidic electrolytic solution is reused, it is neutralized and resultant precipitates are removed, and to an solution separated by filtration, acid is added for adjustment thereof.

The aluminum battery has a voltage of 2.5 volts. When 12 batteries are combined, 42 volts are achieved, which is enough to operate a motor for automobiles (small-size automobile). When an automobile is driven at 80 km/hour for 10 hours in a day, aluminum of the cathode is consumed at 500 g/day. When used for a large-size automobile in the same way, it is consumed at 2-2.5 kg. Thus, when long-distance tracks travel, back-up supplies of aluminum of the cathode may be loaded for convenience.

In the aluminum battery, aluminum of cathodes is dissolved producing hydrogen gas.

When an automobile travels for a day, 500 g of aluminum is consumed. The consumption produces hydrogen gas (0.3×500=150 mol). Thus, the battery can sufficiently be functioned as hydrogen source for fuel cells.

Both electric power from the aluminum battery and electric power from the fuel cell are used in vehicles as power source and for lighting. When a lightweight polyacetylene-lithium storage battery is used, it becomes easy to operate the power source.

As a hydrogen source for fuel cells, two method, i.e., a hydrogen cylinder method and an alcohol method are nearing practical use. The alcohol method carries out the reaction ((CH₃OH)+H₂ORH₂+CO₂). In the reaction, CH₃OH is subject to thermolysis under a low temperature of 300° C. employing catalyst, whereby hydrogen gas is produced. However, CO₂ gas and a trace amount of CO gas are also produced together. Thus, in view of the regulation, which will become effective in 2003 in California, the existence of CO₂ and CO becomes problems.

On the other hand, in the hydrogen cylinder method, supply stations for hydrogen gas will not become widespread as gas stations until 2003. Thus, in preparatory for fuel storage, an aluminum battery and a fuel cell may be combined.

The aluminum batteries are highly safe and secure, and thus placed anywhere.

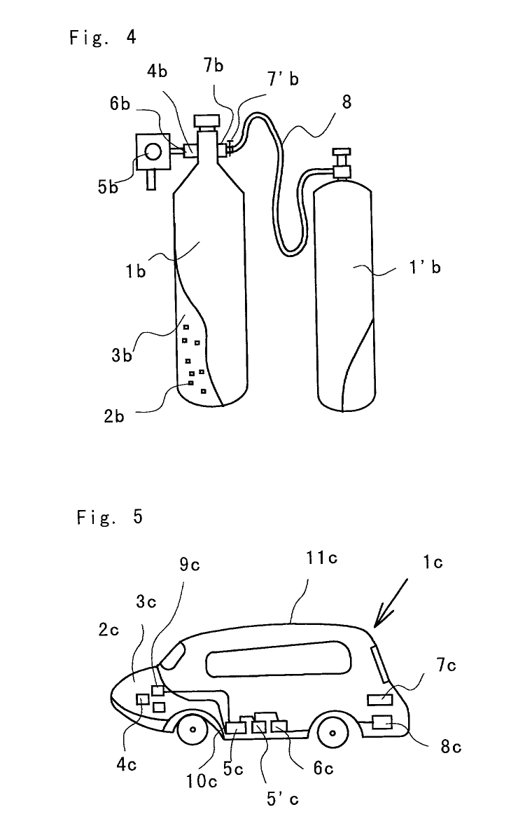

FIG. 4 is a side view of a hydrogen producing tank. In a high-pressure cylinder (1b), aluminum metal blocks (2b) are previously placed and then an alkaline electrolytic solution (3b) is admitted thereinto. After admission, the blocks are dissolved to vigorously produce hydrogen gas. The cylinder (1b) is provided with an upper valve having a suction port (4b) and with a rubber tube fitted onto said port. Then, the air in the cylinder is sucked with a pump (5b), and the valve (6b) is closed to close the cylinder. After closing, hydrogen gradually accumulates in an upper portion of the cylinder. The accumulated hydrogen is fed to a fuel cell through a rubber pipe (8b) by opening the valve (7′b) on an outlet pipe (7b). In this manner, back-up tanks of hydrogen gas are also prepared, and available for supply.

The cylinder (1b) is safe against fire, and reusable several times when blocks and a solution are replaced with new one after blocks are dissolved in a solution. On the other hand, a used solution is also reusable by subjecting it to the treatment for regenerating a waste electrolytic solution mentioned above.

Other examples of metal cathodes for the battery include magnesium, zinc, ferrum, nickel, titanium, zirconium, cadmium, sodium, potassium, lithium and calcium. When an electrolytic solution is aqueous, sodium, potassium, lithium and calcium vigorously dissolve in the solution and explode. Thus, glycol or alcohol may be used as solvent for safety.

In particular, glycol such as titanic acid, zirconic acid, and chelated titanate alcohol liquid dissolve ferrum well, and are inexpensive as a hydrogen source. Then, they are commonly used for small-size fuel cells.

Composition example of the electrolytic solutions are shown as follows:

### EXAMPLE 1

Electrolytic solution for aluminum battery used in automobiles

| | |
|---|---|
| Citric acid | 3% |
| Salt | 10% |
| Caustic soda | 30% |
| Water | 55% |
| Others | 2% |

### EXAMPLE 2

Electrolytic solution for tracks

| | |
|---|---|
| Citric acid | 5% |
| Salt | 12% |
| Caustic soda | 40% |
| Water | 48% |
| Others | 5% |

### EXAMPLE 3

Electrolytic solution for ferrum cathodes

| | |
|---|---|
| 5% titanic acid glycol chelate liquid | 50% |
| Water | 45% |
| Others | 5% |

### EXAMPLE 4

Electrolytic solution for sodium cathode and potassium, calcium, lithium cathode

| | |
|---|---|
| Propylene glycol or ethylene glycol | 90˜100% |
| Water | 0˜10% |

### EXAMPLE 5

Propylene alcohol or butanol, ethylene alcohol, methanol 100%

### EXAMPLE 6

Soda polyacrylate 20˜100%

### EXAMPLE 7

Acidic electrolytic solution

| | |
|---|---|
| Citric acid | 5% |
| Sulfuric acid | 30% |
| Mirabilite | 15% |
| Water | 45% |
| Others | 5% |

### EXAMPLE 8

Electrolytic solution for hydrogen generator

| | |
|---|---|
| Benzaldehyde, or citric acid, malic acid | 2% |
| Tartaric acid, fumaric acid | 5% |
| Water | 3% |
| Salt | 12% |
| Caustic soda | 30% |

FIG. 5 is a side view of an automobile loaded with a fuel cell and the aluminum battery. The automobile (1c) is provided at a front side thereof with a room (2c), and a motor (4c) screwed on said room, which motor drives front wheels thereof. On the room (2c), a bonnet (3c) is mounted, and is opened and closed with a screw plate. Below a driver seat a fuel cell (5c) and a storage battery (6c) are fixed to power the motor (4c). On a rear and lower portion of the automobile a hydrogen generator (7c) for the fuel cell (5c) and an aluminum battery (8c) are installed. From the hydrogen generator (7c) and the aluminum battery (8c), hydrogen is fed to the fuel cell (5c) with a pipe and introduced into a cathode room of the fuel cell (5c). Electric power generated by the aluminum batteries and the fuel cell is stored in the storage battery (6c), and then used to power the motor (4c).

(9c) represents an air-blowing pump, which is used to introduce the air into an anode of the fuel cell (5c) for reaction with hydrogen gas. Resultant water vapor is exhausted with a pipe (10c).

The automobile is further provided on the roof (11c) thereof with solar cells, to generate electric power. Resultant electric power is stored in the storage battery (6c).

(5′c) represents a cylinder containing hydrogen under high pressure and serving as a hydrogen supply source for cathodes of the fuel cell. The hydrogen is produced by dissolving metal block pieces in an electrolytic solution in the cylinder. For that purpose, the cylinder is wrapped therein with an insulting resin.

In light of durability, an electrolytic solution and metal block pieces may be separated from each other in the cylinder.

For higher storage stability, the air in the tank is replaced with inert gas, or hydrogen gas is included into the tank, or the tank is vacuumized. In use, water is introduced into electrolyte powder previously included in the tank, whereby the powder is dissolved to enable metals to dissolve therein.

FIG. 6 is a front view of an aluminum cathode for the aluminum battery. An aluminum metal cathode plate (1Q) is provided with slits (2Q) for a larger contact area with an electrolytic solution. (3Q) represents a raised portion formed on the upper portion of the plate (1Q) to be joined to a conductive wire.

FIG. 7 is an enlarged side view of a fuel cell. The fuel cell comprises an outer body (R), and an inner body (2R) contained in said outer body (R) before closing. In the inner body (2R), a porous core member (3R) is provided that attaches lithium permeable membranes (4R) and (4′R) to both faces thereof. Further, the member (3R) is provided on lower portions of the permeable membranes (4R) and (4′R) with electrodes (5R) and (5′R) attached thereto, and with conductive wires (6R) and (6′R) joined to the electrodes (5R) and (5′R) to take out generated electric power.

Then, the fuel cell is further provided with a conduit pipe (8′R) led to the middle portion of a cathode room (7′R) thereof to introduce hydrogen into the room (7′R), and also with a conduit pipe (8R) led to the middle portion of an anode room (7R) thereof to introduce the air containing oxygen into the room (7R).

When hydrogen contacts a lithium diaphragm (9R), the diaphragm is activated by water to form a diaphragm (9′R) and hydrogen is ionized to release electrons in the cathode room (7′R). On the other hand, oxygen is ionized. Then, resultant hydrogen and oxygen ions are get into contact with each other to produce water. In the process, electrons (2e) are produced and taken out with the electrode (5′R). The process is represented by the formula (2H₂+OR2H₂O+2e⁻).

Single fuel cell has a voltage of 2-3 volts and automobiles require a 35-70 voltage of volts for their motors. Thus, in practical use, the fuel cells are used in combination. Since 10 or more fuel cells are used in combination, the aluminum battery has cost advantage compared with the fuel cell.

For these fuel cells, conventional fuel cells may also be used.

Hydrogen is adjusted in amount and cleaned with a valve before blown into the room.

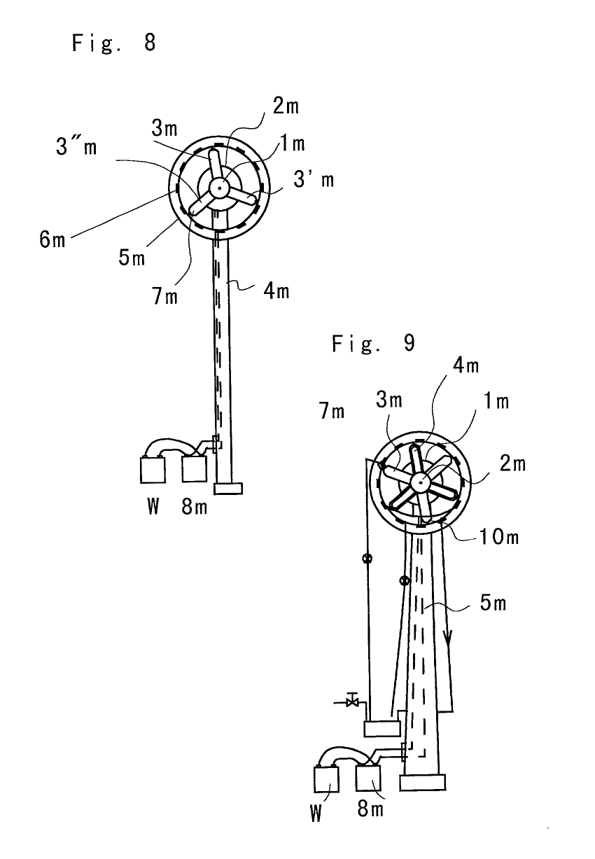

FIG. 8 is a front view of a wind power generator. The wind power generator comprises an electric generator (1m), a rotary shaft (2m) having 3 blades (3m) (3′m) screwed thereon, a hollow metal or ferroconcrete post (4m), and a ring (5m) located on the circumference of the blades (3m) (3′m) and fixed to the post (4m), which generator (1m) is connected to the shaft (2m) to be rotated and screwed to the post (4m). The ring (5m) is provided with a lot of spiral coils (6m). On the other hand, the blades are provided at ends thereof with a lot of permanent magnets (7m). In this construction, when the blades are rotated by wind, magnetic field lines of the permanent magnets are cut by the coils (6m) joined to the ring (5m), whereby electricity is generated. For low resistance when the blades rotate, the magnets may have a pole opposite to that of electromagnets attached to the core shaft (2m) . (8m) represents a storage battery, which is connected to a conducting wire running though the post (4m). (W) represents a high voltage electrolytic device. The storage battery (8m) is stored with electricity and connected to the high voltage electrolytic device (W).

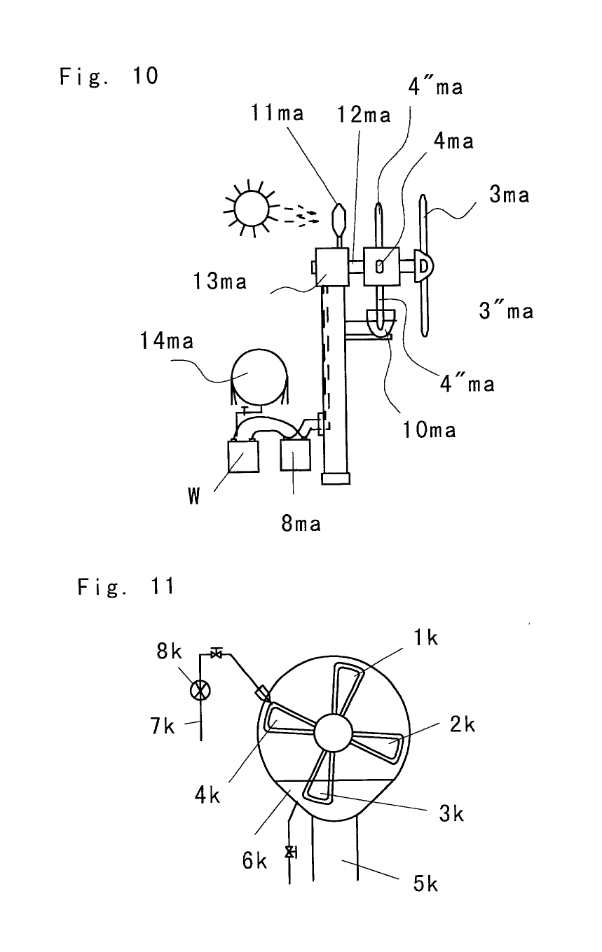

FIG. 9 is a front view of a hot-water-assisted wind power generator. The wind power generator comprises a generator (1n) located in the center axis, and a rotary shaft panel (2n) located in the center axis, which generator (1n) has 4 hollow blades (3n), (3′n), (4n) and (4′n) containing liquid gas therein, which panel (2n) is connected to the generator (1n), which 4 blades (3n), (3′n), (4n) and (4′n) are fixed to the generator (1n) so as to form a cross. The generator (1n) is screwed on an upper portion of a hollow metal or ferroconcrete post (5n) . On the circumference of the 4 blades (3n), (3′n), (4n) and (4′n) a ring (6n) is located, and fixed to the post (5n). Then, the ring (6n) is provided inside with a plurality of spiral coils (7n). On the other hand, the blades are provided at ends thereof with a plurality of permanent magnets (8n) . In this construction, when the blades rotate, the spiral coils (7n) cut magnetic field lines of the magnets (8n), whereby electricity is generated. Resultant electricity is charged in a storage battery connected thereto with conducting wires (8n) and (8′n).

The ring (6n) is provided with an acceptor (10n) fixed to a lower middle portion thereof, and a pipe (9n) The pipe (9n) injects hot water to ends of the blades (4n), whereby the blades (4n) are rotated downward. After rotating the blades (4n) , hot water drops to and pools in the acceptor (10n) , and then falls to a heating tank (12n) through a pipe (11n) . After heating, hot water is sucked and carried again to the pipe (9n) by a pump (13n) for reuse. When the blades are heated at surfaces thereof by injected hot water, ether gas (14n) and (15n) contained in one end of the blades is also heated to turn into vapor, so that vaporized ether gas moves into the opposite end of the blades. Movement of ether gas changes a center of gravity of the blades and continuously rotates the blades. Thus, even when it is windless, the blades can rotate by heating the blade in part by hot water to change a center of gravity thereof. Rotatory power of the blades is used to make the electric generator (1n) rotate and generate electricity. In this construction, higher temperature of hot water may provide faster rotation speed. When the present invention is applied to steel plants, cooling water may be reused effectively as hot water, reducing production cost.

(W) represents a high-voltage electrolytic device. After stored with electric power, a storage battery (8n) is connected to the high-voltage electrolytic device.

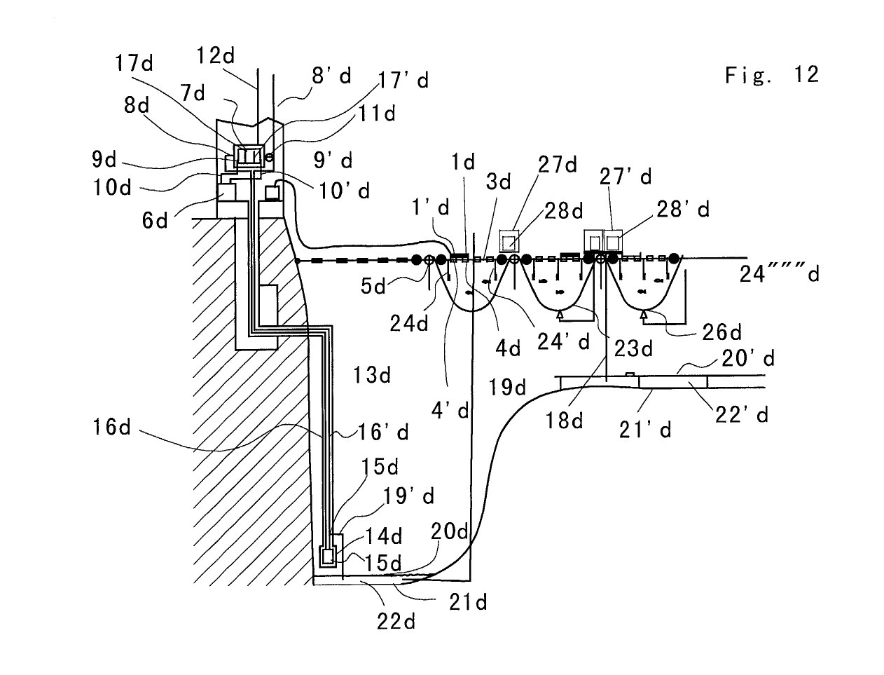

FIG. 10 is a side view of a generator combining a wind power generator with a hot water assisted generator. The generator comprises a rotary shaft (12ma) and 3 rotary blades (3ma), (3′ma) and (3″ma) for wind-power generation, wherein said rotary blades (3ma), (3′ma) and (3″ma) are screwed at even intervals to the forward end of the shaft (12ma) to rotate the shaft (12ma) by wind. The generator is further provided with a hot water assisted wind power generator (S) provided to the shaft (12ma), and 4 blades (4ma), (4′ma), (4″ma) and (4′″ma) attached to the generator (S), and an acceptor (10ma) provided right below the generator (S) to pool hot water. For rotating the blades by changing a center of gravity thereof, the blades are made hollow and provided therein with ether or propane gas. When heated, ether or liquefied propane gas ascends to the opposite end of the blades. For the movement, ether or propane gas may be filled in the blades in the amount of about 50% the inner space of the blades. Ether or propane gas moved from a blade located in the lower position to a blade located in an upper position accumulates in the upper blade to change a center of gravity of the blades. With the change, the upper blade rotates downward. For rotation of the 4 blades, it may be preferred that the blades provided therein with ether or propane gas in the amount of 50% the inner space of the blades.

To the rotary shaft (12ma), a generator (13ma) is connected so that it is rotated by the blades to generate electricity. Result electricity is stored once in a storage battery (8ma) and then applied to an electrolytic device (W) to produce hydrogen. Resultant hydrogen is stored in a gas tank (14ma). Then, hydrogen gas is charged into steel cylinders with a compressor. Hydrogen-filled cylinders are transferred to a hydrogen gas store-places and used in fuel cells.

This hot water assisted wind power generator can always provide certain amount of electricity since it can rotate blades thereof by heating with hot water even when it is windless.

In the past, an experiment was carried out comprising the steps of including ether gas in a glass molding with 2 blades, collecting sunlight and irradiating it to one blade, and then moving ether into the other blade by heating. Even when provided with one blade, a glass molding can rotate well. Then, they can rotate a generator connected to a rotary shaft, whereby electricity is generated. Also, they can appropriately rotate regardless of wind force. When the weather is favorable whole day, electric is generated during the day time. However, blades do not rotate at night. Thus, for rotation of blades, hot water is injected to heat ends of lower blades so that ether ascends and empties the lower blades. As a result, ether is forced to move into upper blades, whereby the upper blades are rotated downward by gravity. When the upper blades rotate and locate at a lower position, hot water is injected thereto for heating, whereby ether moves into the lower blades located at a upper portion to change a center of gravity. In this way, both blades can continuously be rotated. However, rotation by 2 blades cannot be smooth rotation and thus resultant electricity does not have constant current waveform. To avoid this, 4 blades may be provided. In this case, the rotation become smoother and rotation speed is 20-60 rotations.

In this construction, when a blade with a length of 50 cm was used and then the length of 2 blades combined in a line was 1 m, 10 W was generated. In practical use, the length of 2 blades combined in a line was 3-10 m, and generated electricity was 300-100 kW.

FIG. 11 is a side view of a hot water assisted generator. When 3 conventional blades for wind-power generation are combined with a blade for rotation assisted by hot water, they can rotate by heating with hot water even when it is windless. In particular, hot water produced in thermal power generation or metal refining may be used to rotate the blades, providing constant generation. Hot spring water may also be used to rotate the blades. In this constitution, the electricity generated by hot water amount to 50% of electricity generated by wind power.

The generator comprises 4 hollow metal blades (1k), (2k), (3k) and (4k) containing ether or liquid propane gas therein and a post (5k) provided on the top thereof with said blades, which blades are provided at ends thereof with magnets. In this construction, when the blades rotate, magnetic field lines of the magnets are cut by coil cores, whereby electricity is generated. The generator is further provided with an acceptor (6k) provided right below the blades, a pipe (7k) and a pump (8k), wherein the pump (8k) injects hot water from a factory or hot spring water through the pipe (7k) to heat ends of the blades. When heated, ether contained in a blade (4k) is forced to move into a blade (2k). Also, hot water introduced into the acceptor (6k) heats the blade (3k), whereby ether previously contained in the blade (3K) is forced to ascend and accumulate in the blade (1k). The movement changes a center of gravity of the blades and rotates the blades clockwise. Thus, even when it is windless, the blades can rotate by heating.

Resultant electricity may be used in electrolysis of seawater carried out for producing hydrogen in deep waters. The electricity required in the electrolysis under normal pressure is 35 KW/ton, while required in the electrolysis in deep waters is 3.5 KW/ton. This fact means that large amount of hydrogen can be produced with less electricity in deep waters. In other words, this fact promises the possibility of producing hydrogen at a cost 10% of a conventional method. Thus, hydrogen production in the sea may be useful for operating fuel cells.

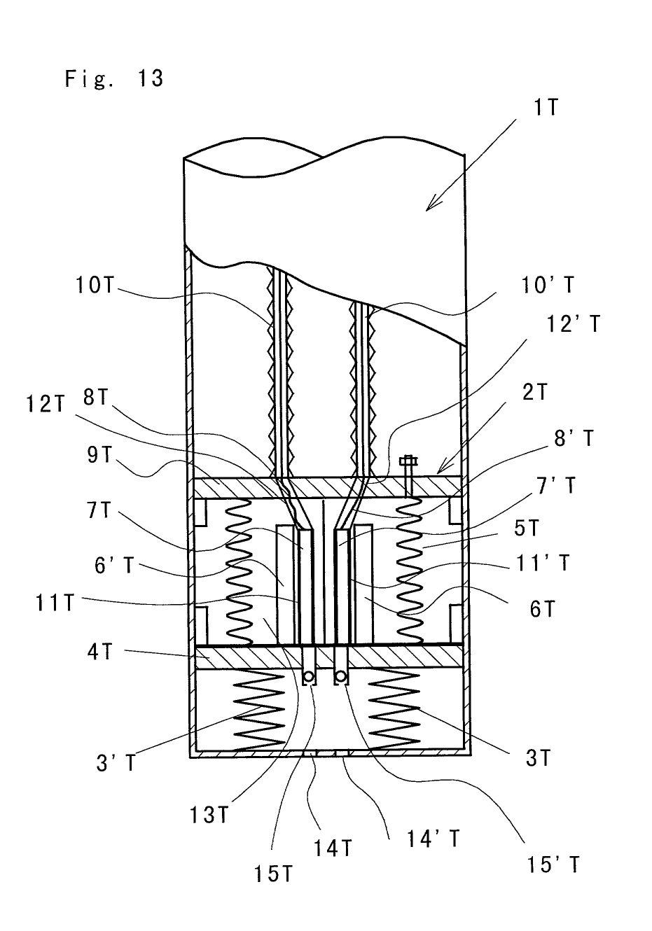

FIG. 12 is a side view of a combination of an electrolytic device located in deep waters, a solar battery system on the sea and rafts for cultivating fish and shellfish. On a number of foam polystyrene plate floats (1d), solar batteries (1′d) are attached and combined thereto by ropes (3d). The floats are connected to tower-like floats (4d) and (4′d), and to barrel floats (5d), (5′d), (5″d) and (5′″d) for floatation on the sea, to conduct photovoltaic generation.

Electricity generated by the solar battery is stored for a time in a storage battery (6d). The storage battery (6d) is connected to a fuel cell (7d) with a conductive wire. The fuel cell (7d) is further provided with a pipe (8d) to introduce hydrogen gas thereinto, and with a cathode (9d) and anode (9′d) connected to the storage battery (6d) with conducting wires (10d) (10′d). Thus, electricity generated by the fuel cell (7d) is also stored in the battery (6d). The fuel cell (7d) is also provided with a pump (11d) and a pipe (8′d), which pump (11d) blows hydrogen-containing air thereinto through said pipe (8′d). In power generation of the fuel cell, hydrogen reacts with oxygen to produce water, with the release of electrons. Resultant water is discharged from a pipe (12d). Electric power stored in the storage battery (6d) is applied to an electrolytic device (15d) in the bottom (14d) of a pipe (13d). The pipe (13d) is extended to depth of 250 m, and the electrolytic device (15d) is installed in the bottom (14d). Then, the electrolytic device (15d) is operated to carry out electrolysis under high water pressure. Then, resultant hydrogen is fed through a pipe (16d) and blown into the cathode (9d) while resultant oxygen is fed through a pipe (16′d) and blown into the anode (9′d). Blown hydrogen and oxygen are contacted and reacted with each other in diaphragm (17d) and (17′d), whereby electricity is generated. Resultant electricity is stored in the storage battery (6d).

The electrolytic device (15d) is provided with valves (18d) and (18′d) to adjust the amount of seawater before introduced thereinto.

For another use of resultant oxygen, a pipe (19d) is branched from the pipe (16′d) and connected to a plastic sheet (20d) so that one part of resultant oxygen is fed and blown into the sheet (20d). Then, sludge (22d) between the sheet (20d) and the sea bottom (21d) are oxidized by resultant oxygen so that aerobic bacteria in the sludge are activated to decompose the sludge. As a result, harmful effects against cultured fish and the emergence of red tide can be prevented.

Seawater is sucked for electrolysis at a depth of around 250 meter while fish or shellfish is generally cultivated in a shallow sea using nets for cultured fish (23d) and (23′d). Then, a solar battery system is floated on the sea with depths of 10-20 meter in most cases. When pearls are cultivated, nets for pearl cultivation (24d), (24′d), (24″d), (24′″d), (24″″d) and (24′″″d) are attached to tower-like floats for floatation. In cultivating fish or shellfish, the plastic sheet (20d) is bed on the sludge (22′d) on the sea bottom (21′d), and resultant oxygen is blown into the sludge (22′d) through the pipe (19′d), so that the sludge (22′d) is oxidized and aerobic bacteria are propagated. As a result, adverse effects produced by sulfuretted hydrogen can be prevented and factors of red tide can be removed. The nets for culturing fish (23d), (23′d) and (23″d) may be provided at a center thereof with pipes (26d), (26′d) and (26″d), with sucking pumps (27d), (27′d) and (27″d), and with filters (28d), (28′d) and (28″d). In this case, deposit of sprinkled bait in the nets are sucked by the pumps through pipes, and then separated by the filters. In this way, seawater containing residue, which may cause red tide, is separated from residue and returned to the sea. On the other hand, uneaten bait is separated before recovery and then remolded for reuse.

In this case, oxygen is used to oxidize and decompose sludge so that pollution is reduced with less damage to sea farming. In general, 50% of young yellowtails die while cultivating. However, when the above remolded feed is added by a nutrient additive and given to young yellowtails, the death rate of them falls down to 5%.

Pollution on the sea bottom occurs when oxygen is scarce in seawater. Thus, hydrogen sulfide gas is not produced when oxygen is abundant in seawater. When seawater is electrolyzed, chlorine gas is produced together with oxygen gas.

In the electrolysis, biocidal chlorine and oxygen are produced mixing with each other, and HClO is also produced in part. Said products are used for oxidation on the sea bottom.

However, it is undesirable that oxygen gas is contaminated by chlorine when being blown into the fuel cell. Thus, before blown into the fuel cell, oxygen is passed through a tank containing alkaline water taken from cathodic water in the electrolytic device to neutralize chlorine mixed with oxygen. In stead of the resultant oxygen, the atmospheric gas may be blown into the fuel cell under normal pressure.

The oxidation of seawater or production of hydrogen requires large electric power. Thus, wind-power generation may be combined with photovoltaic generation.

Wind power generators comprises a rotary shaft, a conventional blade body provided at regular intervals with 3 blades and fixed to said shaft, electromagnets attached to said shaft, and a post. Then, the blades rotate by wind so that magnetic field lines are cut to generate electricity in electromotive coils. Resultant electricity is fed to a storage battery with a conductive wire running through the post. After stored in the storage battery, electricity is used. In conventional wind power generation, when it is windless, blades can not rotate. Thus, generated electricity is not always constant.

FIG. 13 is an expanded side view of an electrolytic device placed on springs (3T) and (3′T) provided on the bottom of a pipe (1T) . The electrolytic device (2T) comprises a metal plate (4T) placed on the springs, a rubber or plastic bag (5T) placed on said plate, supporting protrusion stands (6T) and (6′T) provided in said bag and joined to said plate, a metal cathode (7T), a metal anode (7′T), both of which held in vertical by said stands, and a metal plate (9T) formed with holes provided to an upper portion thereof. The electrodes are connected to conductive wires (8T) and (8′T) running through the holes of the plate (9T) and led to pipes (10T) and (10′T), whereby the electrodes are suspended from the pipes. Then, the cathode (7T) and anode (7′T) are covered with reverse osmosis membrane resin film bags (11T) and (11′T), respectively. The bags are connected at upper portions thereof to rubber tubes (12T) and (12′T). In this construction, resultant hydrogen gas goes up through the bag (11T) and the rubber tube (12T), and is fed through the pipe to the fuel cell. On the other hand, resultant oxygen gas or the like goes up through the bag (11′T) and the tube (12′T), some of which are introduced into the fuel cell and the other is used to oxidize the sea bottom.

Water pressure is high in deep waters. To utilize the high pressure, the rubber tubes may be made of elastic rubber, synthetic rubber, or thick rubber-laminated cloth.

When the bottom of the pipe (1T) is introduced from the shallow sea to the deep sea, electrolytic solution contained therein is compressed so that electrolysis efficiency is increased. The pipe (1T) serving as an outer housing is formed at the bottom thereof with holes (14T) and (14′T) to introduce seawater thereinto. When electrolysis is carried out under 30-100 air pressures on land, a press pump is used to blow gas into an electrolytic device. In this case, an electrolysis ion transportation value is increased.

The electrolytic device is further provided with valves (15T) and (15′T) to supply an electrolysis bath therein with an electrolytic solution.

A plurality of electrolytic devices may be combined.

Hydrogen generated by electrolysis carried out in the electrolytic device (2T) is fed to a hydrogen tank (P) on land through the rubber tube (12T) and the pipe (10T), and stored therein for a time. Then, the hydrogen is introduced for reaction into a cathode room (9T) of a fuel cell (7T). Also, resultant oxygen and/or chlorine are used, in particular, to oxidize and decompose feed deposited on the sea bottom below nets for cultivating fish and shellfish, whereby the emergence of red tide plankton can be prevented.

With a conventional net case, 50% of sprinkled bait falls down from the case and deposits on the sea bottom. Then, deposited bait is decomposed by anaerobes, whereby harmful hydrogen sulfide, mercaptan, trimethanol amine or ammonia is produced. Resultant products pollute the sea. In the polluted sea, 50% of young yellowtails die while cultivating, with low profitability. However, when a net is closed at the bottom thereof and provided with a sump pump and a filter as described above, production of sludge can be reduced. Further, when sea bottom is oxidized with oxygen and the like as described above, emergence of harmful plankton can be prevented.

Most of automobiles use fossil fuel as fuel therefor. However, the use of fossil fuel may responsible for global warming or air pollution. Thus, emission control will be introduced until 2003. In the above situation, fuel cells attract much attention and are studied worldwide toward practical use because they can generate energy by reacting hydrogen with oxygen, with emission of only water. Before practical use of fuel cells, a lot of problems regarding hydrogen supply remain unsolved. For example, hydrogen must be produced at even lower costs; exiting “gas” stations must be changed to “hydrogen gas” station; since high pressure gas is handled, greater safety is required and thus apparatus supplying automobiles with hydrogen must be high pressure gas tanks and supply apparatus different from those for gasoline; in addition, it is difficult only in Japan to replace automobiles driven by oil with automobiles driven by hydrogen. Based on the above difficulties, it is said that it may be 7 years before fuel cells are made available to the public though they come into practical use.

By producing metal electrolysis batteries described above, which are more easily available than fuel cells, automobiles can be driven by metal electrolysis batteries such as aluminum batteries instead of fuel cells, which use hydrogen gas, or driven by both of them. In the case where metal electrolysis batteries are combined with fuel cells, it is possible to recover and use hydrogen gas, produced as by-products when metals dissolve in the batteries, as fuel in the fuel cells. As a result, fuel costs of automobiles can be reduced by as much as 20%. Further, even if supply of hydrogen gas is suddenly stopped while driving, fuel cells can be operated by the operation of metal electrolysis batteries and thus accidents may be prevented since the batteries produce hydrogen. Also, when a hydrogen producer, which produces hydrogen by dissolving metal block pieces, is loaded on an automobile as a supplementary hydrogen generator, hydrogen can be promptly supplied to fuel cells when hydrogen is needed urgently.

As hydrogen cylinders are sold, the generators can be sold at gas stations. In addition, since the generators have relatively low pressure compared with hydrogen cylinders, they are flame-retardant, less likely to explode and thus safe.

In the future, new thermal power plants may not be build because of pollution gas, or production thereof may not easily be approved. Then, the age may begin when fuel cells reacting hydrogen with oxygen are actually used as a clean alternate energy. In Germany, an equipment for producing hydrogen comes into practice. The equipment comprises a solar generator attached to roofs of housing to generate energy, and an electrolytic device to produce hydrogen with consuming electricity fed from the solar generator. However, such equipment produces hydrogen at high costs, and hydrogen must be produced at costs reduced by at least 30%. On the other hand, a conventional wind power generator generate 1000 KW. However, with respect to installation locations and high installation cost, wind power generators must be rationalized and improved. In view of the above situation, conventional stereotype had to be reviewed.

As a hydrogen source, metal electrolysis batteries such as aluminum batteries, magnesium, zinc, ferrum, sodium, potassium, lithium, titanium, zirconium, calcium metal batteries may be combined with a fuel cell. In conventional metal batteries, when metals are dissolved, hydrogen is produced. Thus, since the voltage of metal batteries depends on hydrogenation reaction, larger output of batteries requires larger amount of metal to be consumed. Resultant hydrogen in a metal battery is fed to and used in a fuel cell for power generation therein. In this case, electric power generated by fuel cells and electric power generated by metal batteries is used together. As a result, the consumption of hydrogen can be reduced. Also, the fuel cell and the metal battery are less likely to explode in flames and thus safe in the event of an automobile crash. Further, metal electrodes of the metal batteries are not wastefully consumed when the batteries are not operative by moving an electrolytic solution. This increases efficiency of electric generation by not less than 10%, compared with a storage battery.

When only fuel cells need to be operated, an electrolytic solution is introduced, as need arises, into a tank previously provided therein with metal pieces, whereby hydrogen is produced in the tank. If the air in a tank is previously extracted or replaced with inert gas by blowing the inert gas into the tank, the tank has no risk of explosion and can reduce the amount of metal electrodes to be consumed.

Thus, even though an automobile runs out of hydrogen while driving, the automobile can be supplied with hydrogen as described above without coming to a halt. As an advantage of the metal batteries, they as well as fuel cells do not pollute the air. Then, if automobiles carry backup metal cathodes, metal cathodes can easily be replaced with the backups when the metal batteries are consumed.

The problem of metal batteries is a waste electrolytic solution. The filtrate of a waste electrolytic solution can be recycled by adjusting the filtrate with acid/alkaline water. Also, a waste solution is neutralized and resultant precipitate is separated by filtration. Then, the resultant solid may be used for fireproof materials and the like, and the resultant filtrate is adjusted and can be reused for an electrolytic solution. When a waste electrolytic solution can be recycled in this way, the pollution caused by a waste solution can be prevented.

The waste solution, particularly waste solution from aluminum cathode batteries, may be used as a precipitant and as a depurator for industrial waste water. In this case, it also removes the odor in disposal of excreta.

In order to generate electricity at lower costs consumed in electrolysis for producing hydrogen, a hot water assisted wind power generator is used. Though a wing power generator cannot rotate blades thereof when it is windless, a hot water assisted wind power generator can rotate blades thereof by using hot water when it is windless. Thus, the hot water assisted wind power generator has electric generating capacity 20% larger than a wind power generator, and also improves pollution caused by dumped hot water since it uses hot water therefor. This reuse of heat of wasted hot water is an effective use of waste heat in factories or power plants. Also, in order to generate electricity consumed in electrolysis for producing hydrogen, a solar battery system is employed. The solar battery system comprises foam floats on the sea and solar cells attached to said floats. The floats may be connected to, in particular, tower-like floats fixed to nets for fish preserves used as live boxes. Then, electric power generated by the generator is fed to and consumed in an electrolytic device, to produce hydrogen. As seen from the above, the present invention has applications on land and in the sea. For example, the invention can prevent pollution on the sea bottom, caused by sinking of uneaten scattered bait for cultivation, and also oxidize sludge on the sea bottom, so that sludge on the sea bottom can be reduced.

When the invention is applied to apparatus for generating electricity in deep waters, the electrolytic device is installed in an apparatus for taking deep sea water therein. In this case, electric energy fed from the solar battery system is consumed in the electrolysis of sea water but reduced in costs by not less that 50% due to high water pressure. In other words, the production cost of hydrogen is reduced by about 50%.

Based on the above facts, employing hydrogen in large quantities in accordance with the present invention is economic. Thus, the present invention is industrially beneficial.

Waste metal or scrape of aluminum metal, magnesium alloy and the like may be hydrogen source since they produce hydrogen when reacted with an electrolytic solution. Also, sintered plates may be metal cathodes, and thus very inexpensive hydrogen source and used as very inexpensive cathodes in metal (e.g. aluminum) batteries.

The present invention produces hydrogen economically used as fuel for fuel cells, and promotes practical application of fuel cells since it help save various spending for, e.g., provision of hydrogen gas stations when fuel consumed in vehicles is switched from fossil fuel to hydrogen. In addition, the present invention provides metal batteries, particularly aluminum batteries, which are available as a supply source of hydrogen for fuel cells and also capable of rotating motors for automobiles. Thus, when crashed, vehicles are free from the risk of explosion in flames due to low hydrogen pressure.

According to the present invention, electric power required for electrolysis can be reduced by carrying out the electrolysis in deep waters. In addition, electricity generated by photovoltaic generation on the sea or wind power generation may be used in the electrolysis. The reduction and the use reduce production cost of hydrogen by not less than 20%. Also, the present invention contributes to large scale electric generation by fuel cells, and reduces production cost by electric generation in factories. Further, hydrogen produced at low cost in accordance with the present invention has wide applications such as a reductant in refinery process of sintered metal by powder metallurgy, and catalysts in oil refineries or chemical factories.

1. A fuel cell system comprising at least one unit of fuel cells and auxiliary soluble metal anode batteries for producing hydrogen gas by dissolution of a soluble metal in an electrolyte.

2. A fuel cell system comprising fuel cells; an electrolysis system operated under a high pressure to generate hydrogen gas and oxygen gas and adapted to supply these gases to said fuel cells, and an auxiliary power source for supplying an electric power to said electrolysis system.

3. The fuel cell system according to claim 2, wherein said auxiliary power source is metal anode batteries.

4. The fuel cell system according to claim 3, wherein said metal anode batteries generally comprises soluble metal anodes and insoluble cathodes separated one another by separators and arranged in a casing or tank containing an electrolyte.

5. The fuel cell system according to claim 2, wherein said auxiliary power source is wind power generators.

6. The fuel cell system according to claim 2, wherein said auxiliary power source is solar battery system.

7. The fuel cell system according to claim 2, wherein said an electrolysis system is a high pressure electrolysis system.
